(19) United States
(12) Patent Application Publication
(10) Pub. No.: US 2006/0007941 A1
(43) Pub. Date: Jan. 12, 2006

(54) Distributed computing environment controlled by an appliance

(75) Inventors: Robert A. Fabbio, Austin, TX (US); James M. Mott, Austin, TX (US); Samuel R. Locke, Richardson, TX (US)

Correspondence Address: TOLER & LARSON & ABEL L.L.P., 5000 PLAZA ON THE LAKE STE 265, AUSTIN, TX, 78746, US

(73) Assignee: VIEO, Inc.

(21) Appl. No.: 10/885,216

(22) Filed: Jul. 6, 2004

(51) Int. Cl. H04L 12/26; H04L 12/28

(52) U.S. Cl. 370/400; 370/469

(57) ABSTRACT

Systems are described which allow management communications in an application infrastructure irrespective of the functional states of various components in the application infrastructure. Components in the application infrastructure may be coupled to a management interface component, which may in turn be coupled to a central management component. Communications from the central management component may be routed to a local management interface component, and from that local management interface component to another component in the application infrastructure for which the management communication is intended. In this manner, such other component may be accessed (for purposes of management) regardless of the functional state of the other application infrastructure components in the application infrastructure.

### RELATED APPLICATIONS

This application is related to U.S. patent application Ser. No. 10/826,719, entitled “Method and System For Application-Aware Network Quality of Service” by Thomas P. Bishop et al., filed on Apr. 16, 2004, and U.S. patent application Ser. No. 10/826,777 entitled “Method and System for an Overlay Management Network” by Thomas P. Bishop et al., filed on Apr. 16, 2004, both of which are assigned to the current assignee hereof and incorporated herein by reference in their entireties.

### FIELD OF THE DISCLOSURE

The invention relates in general to systems for controlling a distributed computing environment, and more particularly, to a distributed computing environment that is controlled by an appliance.

### DESCRIPTION OF THE RELATED ART

Distributed computing environments are extensively used in computing applications. The distributed computing environments are growing more complex. In order to manage and control the distributed computing environment, two approaches are typically taken: parallel networks and software-based management tools.

Parallel networks allow content traffic to be routed over one network and management traffic to be routed over a separate network. The public telephone system is an example of such a parallel network. The content traffic can include voice and data that most people associate with telephone calls or telephone-based Internet connections. The management traffic controls network devices (e.g., computers, servers, hubs, switches, firewalls, routers, etc.) on the content traffic network, so that if a network device fails, the failed network device can be isolated, and content traffic can be re-routed to another network device without the sender or the receiver of the telephone call perceiving the event. Parallel networks are expensive because two separate networks must be created and maintained. Parallel networks are typically used in situations were the content traffic must go through regardless of the state of individual network devices within the content traffic network.

Software-based management applications work poorly because of their inherent limitations, in that the content traffic and the management traffic share the same network. FIG. 1 includes a typical prior art application infrastructure topology that may be used within a distributed computing environment. An application infrastructure 110 may include two portions 140 and 160 that can be connected together by a router 137. Application servers 134 and database servers 135 reside in the portion 140. Web servers 133 and workstation 138 reside in the portion 160. In order for any one of network devices within the portion 140 to communicate with any one of the network devices within the portion 160, the communication must pass through the router 137.

One network device (e.g., workstation 138) may be designated as a management component for the distributed computing environment. The workstation 138 may be responsible for managing and controlling the application infrastructure 110, including all network devices. However, if router 137 is malfunctioning, workstation 138 may not be able to communicate with network devices (e.g., the application servers 134 and database servers 135) in the portion 140. Consequently, while the router 137 is non-functional, network devices in the portion 140 are without management and control. The workstation may not effectively manage and control the distributed computing environment in a coherent manner because the workstation 138 cannot manage and control network devices within the portion 140.

Another problem with the application infrastructure 110 is its in ability to effectively address a broadcast storm. For example, a malfunctioning component (hardware, software, or firmware) within the portion 140 may cause a broadcast storm. The router 137 and its network connections have a limited bandwidth and may effectively act as a bottleneck. The broadcast storm may swamp the router 137 with traffic. By the time the workstation 138 detects the broadcast storm, it may be too late to address the broadcast storm. Management traffic from the workstation 138 competes with content traffic from the broadcast storm, and therefore, the management traffic cannot correct the problem until after the broadcast storm subsides. During the broadcast storm, the network devices (e.g., the application servers 134 and database servers 135) within the portion 140 operate without management and control because the management traffic competes with the content traffic on the same shared network.

### SUMMARY

A distributed computing environment includes a network that is shared by content traffic and management traffic. Effectively, a management network is overlaid on top of a content network, so that the shared network operates similar to a parallel network, but without the cost and expense of creating a physically separate parallel network. Packets that are transmitted over the network are classified as management packets (part of the management traffic) or content packets (part of the content traffic). After being classified, the packets can be routed as management traffic or content traffic as appropriate. Because at least some of the shared network is reserved for management traffic, management traffic can reach the network devices, including a network device from which a broadcast storm originated. Therefore, network traffic can be segregated into management traffic and content traffic with the advantages of a separate parallel network but without its disadvantages, and with the advantages of a shared network but without its disadvantages.

The distributed computing environment can include an application infrastructure where all network devices within the distributed computing environment are directly connected to an appliance that manages and controls the distributed computing network. Knowledge of the functional state of and the ability to manage any network device within the distributed computing environment is not dependent on the functional state of any other network device within the application infrastructure. Management packets between the appliance and the managed components within the distributed computing environment are effectively only “one hop” away from their destination.

The configuration of the distributed computing environment also allows for better visibility of the entire application infrastructure. In the prior art, some network devices may not be visible if an intermediate network device (e.g., the router 137), which lies between another network device (e.g., the application servers 134 and database servers 135) and a central management component (e.g., the workstation 138), malfunctions. Unlike the prior art, direct connections between the network devices and the appliance allow for better visibility to each of the network devices, components within the network devices, and all network traffic, including content traffic, within the distributed computing environment.

The foregoing general description and the following detailed description are illustrative and explanatory only and are not restrictive of the invention.

### BRIEF DESCRIPTION OF THE DRAWINGS

The present invention is illustrated by way of example and not limitation in the accompanying figures, in which the same reference number indicates similar elements in the different figure.

FIG. 1 includes an illustration of a prior art application infrastructure.

FIG. 2 includes an illustration of a hardware configuration of an appliance for managing and controlling a distributed computing environment.

FIG. 3 includes an illustration of a hardware configuration of the application infrastructure management and control appliance in FIG. 2.

FIG. 4 includes an illustration of a hardware configuration of one of the management blades in FIG. 3.

FIG. 5 includes an illustration of a network connector, wherein at least one connector is reserved for management traffic and other connectors can be used for content traffic.

FIG. 6 includes an illustration of a bandwidth for a network, wherein at least one portion of the bandwidth is reserved for management traffic and another portion of the bandwidth can be used for content traffic.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

A distributed computing environment includes a management network that is overlaid on top of a content network. The shared network operates similar to a parallel network, but without the cost and expense of creating a physically separate parallel network. Because at least some of the shared network is reserved for management traffic, management traffic can reach the network devices, including a network device from which a broadcast storm originated. Therefore, network traffic can be segregated into management traffic and content traffic with the advantages of a separate parallel network but without its disadvantages, and with the advantages of a shared network but without its disadvantages.

The distributed computing environment can include an application infrastructure where all network devices within the distributed computing environment are directly connected to an appliance that manages and controls the distributed computing network. Knowledge of the functional state of and the ability to manage any network device within the distributed computing environment is not dependent on the functional state of any other network device within the application infrastructure. Management packets between the appliance and the managed components within the distributed computing environment are effectively only “one hop” away from their destination.

A few terms are defined or clarified to aid in understanding the terms as used throughout this specification. The term “application” is intended to mean a collection of transaction types that serve a particular purpose. For example, a web site store front can be an application, human resources can be an application, order fulfillment can be an application, etc.

The term “application infrastructure” is intended to mean any and all hardware, software, and firmware connected to an application management and control appliance. The hardware can include servers and other computers, data storage and other memories, switches and routers, and the like. The software used may include operating systems, databases, web servers, and the like. The application infrastructure can include physical components, logical components, or a combination thereof.

The term “central management component” is intended to mean a component which is capable of obtaining information from management execution component(s), software agents on managed components, or both, and providing directives to the management execution component(s), the software agents, or both. A control blade is an example of a central management component.

The term “component” is intended to mean a part within an application infrastructure. Components may be hardware, software, firmware, or virtual components. Many levels of abstraction are possible. For example, a server may be a component of a system, a CPU may be a component of the server, a register may be a component of the CPU, etc. For the purposes of this specification, component and resource can be used interchangeably.

The term “content traffic” is intended to mean the portion of the network traffic that is used by application(s) running within a distributed computing environment.

The term “distributed computing environment” is intended to mean a collection of (1) components comprising or used by application(s) and (2) the application(s) themselves, wherein at least two different types of components reside on different network devices connected to the same network.

The term “instrument” is intended to mean a gauge or control that can monitor or control a component or other part of an application infrastructure.

The term “logical,” when referring to an instrument or component, is intended to mean an instrument or a component that does not necessarily correspond to a single physical component that otherwise exists or that can be added to an application infrastructure. For example, a logical instrument may be coupled to a plurality of instruments on physical components. Similarly, a logical component may be a collection of different physical components.

The term “management infrastructure” is intended to mean any and all hardware, software, and firmware that are used to manage or control an application.

The term “management execution component” is intended to mean a component in the flow of network traffic that may extract management traffic from the network traffic or insert management traffic into the network traffic; send, receive, or transmit management traffic to or from any one or more of the appliance and software agents residing on the application infrastructure components; analyze information within the network traffic; modify the behavior of managed components in the application infrastructure, or generate instructions or communications regarding the management and control of any portion of the application infrastructure; or any combination thereof. A management blade is an example of a management execution component.

The term “management traffic” is intended to mean the portion of the network traffic that is used to manage and control a distributed computing environment.

The term “network device” is intended to mean a Layer 2 or higher device in accordance with the Open System Interconnection (“OSI”) Model.

The term “network traffic” is intended to mean all traffic, including content traffic and management traffic, on a network of a distributed computing environment.

As used herein, the terms “comprises,” “comprising,” “includes,” “including,” “has,” “having” and any variations thereof, are intended to cover a non-exclusive inclusion. For example, a method, process, article, or appliance that comprises a list of elements is not necessarily limited to only those elements but may include other elements not expressly listed or inherent to such method, process, article, or appliance. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. Although methods, hardware, software, and firmware similar or equivalent to those described herein can be used in the practice or testing of the present invention, suitable methods, hardware, software, and firmware are described below. All publications, patent applications, patents, and other references mentioned herein are incorporated by reference in their entirety. In case of conflict, the present specification, including definitions, will control. In addition, the methods, hardware, software, and firmware and examples are illustrative only and not intended to be limiting.

Unless stated otherwise, components may be bi-directionally or uni-directionally coupled to each other. Coupling should be construed to include direct electrical connections and any one or more of intervening switches, resistors, capacitors, inductors, and the like between any two or more components.

To the extent not described herein, many details regarding specific network, hardware, software, firmware components and acts are conventional and may be found in textbooks and other sources within the computer, information technology, and networking arts.

Before discussing details of the embodiments of the present invention, a non-limiting, illustrative hardware architecture for using embodiments of the present invention is described. After reading this specification, skilled artisans will appreciate that many other hardware architectures can be used in carrying out embodiments described herein and to list every one would be nearly impossible.

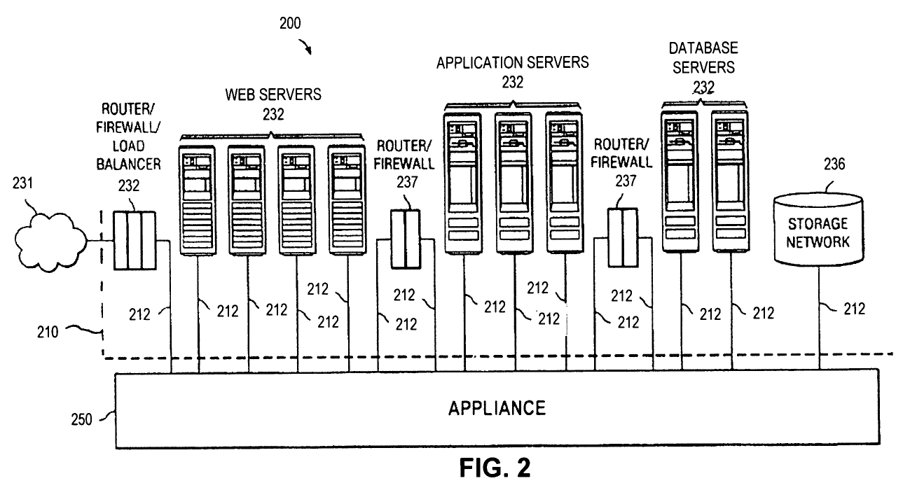

FIG. 2 includes a hardware diagram of a distributed computing environment 200. The distributed computing environment 200 includes an application infrastructure. The application infrastructure includes management blade(s) (not shown in FIG. 2) within an appliance 250 and those components above and to the right of the dashed line 210 in FIG. 2. More specifically, the application infrastructure includes a router/firewall/load balancer 232, which is coupled to the Internet 231 or other network connection. The application infrastructure further includes web servers 233, application servers 234, and database servers 235. Other servers may be part of the application infrastructure but are not illustrated in FIG. 2. Each of the servers may correspond to a separate computer or may correspond to a virtual engine running on one or more computers. Note that a computer may include one or more server engines. The application infrastructure also includes a network 212, a storage network 236, and router/firewalls 237. The management blades within the appliance 250 may be used to route communications (e.g., packets) that are used by applications, and therefore, the management blades are part of the application infrastructure. Although not shown, other additional components may be used in place of or in addition to those components previously described.

Each of the network devices 232-237 is bi-directionally coupled in parallel to the appliance 250 via network 212. Each of the network devices 232-237 is a component, and any or all of those network devices 232-237 can include other components (e.g., system software, memories, etc.) inside of such network devices 232-237. In the case of the router/firewalls 237, the inputs and outputs from the router/firewalls 237 are connected to the appliance 250. Therefore, substantially all the traffic to and from each of the network devices 232-237 in the application infrastructure is routed through the appliance 250. Software agents may or may not be present on each of the network devices 232-237 and their corresponding components. The software agents can allow the appliance 250 to monitor and control at least a part of any one or more of the network devices 232-237 and their corresponding components. Note that in other embodiments, software agents on components may not be required in order for the appliance 250 to monitor and control the components.

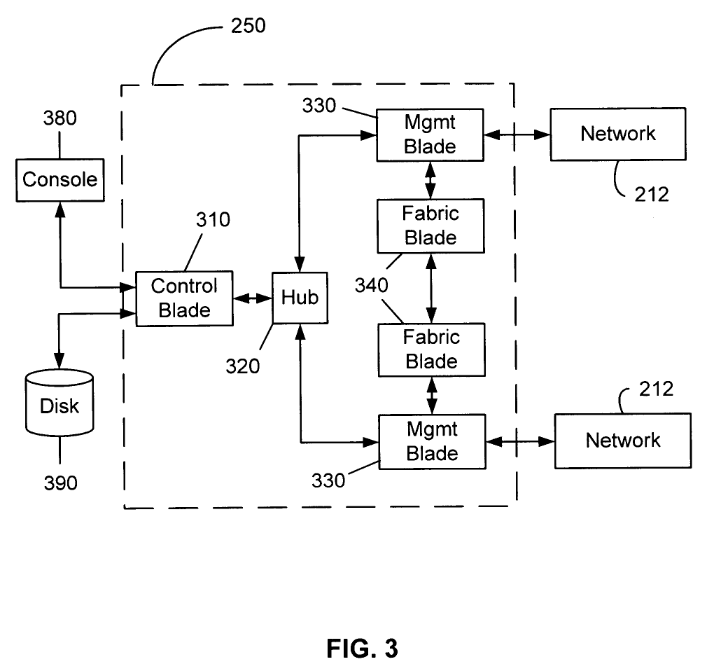

FIG. 3 includes a hardware depiction of the appliance 250 and how it is connected to other parts of the distributed computing environment 200. A console 380 and a disk 390 are bi-directionally coupled to a control blade 310 within the appliance 250. The control blade 310 is an example of a central management component. The console 380 can allow an operator to communicate with the appliance 250. Disk 390 may include logic and data collected from or used by the control blade 310. The control blade 310 is bi-directionally coupled to a hub 320. The hub 320 is bi-directionally coupled to each management blade 330 within the appliance 250. Each management blade 330 is bi-directionally coupled to the network 212 and fabric blades 340. Two or more of the fabric blades 340 may be bi-directionally coupled to one another.

The management infrastructure can include the appliance 250, network 212, and software agents on the network devices 232-237 and their corresponding components. Note that some of the components within the management infrastructure (e.g., the management blades 330, network 212, and software agents on the components) may be part of both the application and management infrastructures. In one embodiment, the control blade 310 is part of the management infrastructure, but not part of the application infrastructure

Although not shown, other connections and additional memory may be coupled to each of the components within the appliance 250. Further, nearly any number of management blades 330 may be present. For example, the appliance 250 may include one or four management blades 330. When two or more management blades 330 are present, they may be connected to different parts of the application infrastructure. Similarly, any number of fabric blades 340 may be present. In still another embodiment, the control blade 310 and hub 320 may be located outside the appliance 250, and in yet another embodiment, nearly any number of appliances 250 may be bi-directionally coupled to the hub 320 and under the control of the control blade 310.

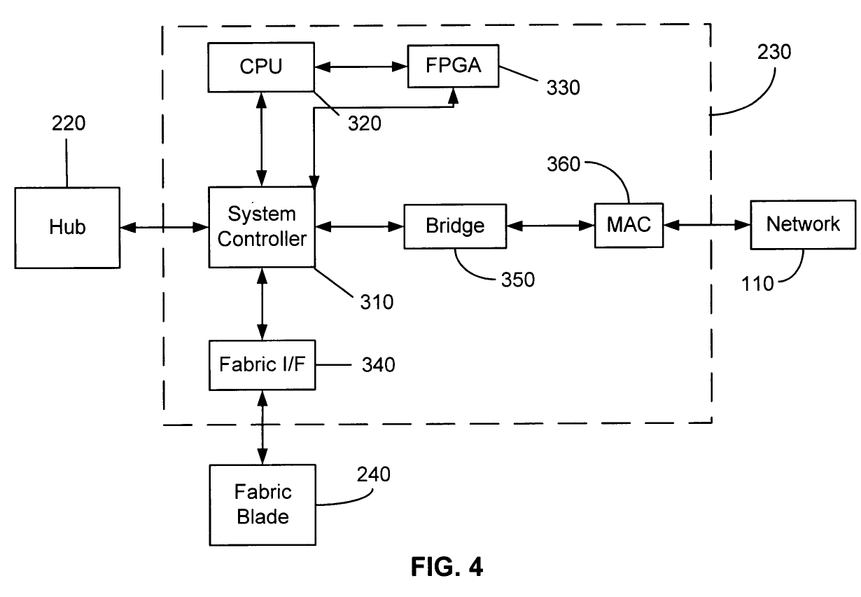

FIG. 4 includes an illustration of one of the management blades 330. Each of the management blades 330 is an illustrative, non-limiting example of a management execution component and has logic to act on its own or can execute on directives received from the central management component (e.g., the control blade 310). In other embodiments, a management execution component does not need to be a blade, and the management execution component could reside on the same blade as the central management component. Some or all of the components within the management blade 330 may reside on one or more integrated circuits.

Each of the management blades 330 can include a system controller 410, a central processing unit (“CPU”) 420, a field programmable gate array (“FPGA”) 430, a bridge 450, and a fabric interface (“I/F”) 440, which in one embodiment includes a bridge. The system controller 410 is bi-directionally coupled to the hub 320. The CPU 420 and FPGA 430 are bi-directionally coupled to each other. The bridge 450 is bi-directionally coupled to a media access control (“MAC”) 460, which is bi-directionally coupled to the application infrastructure. The fabric I/F 440 is bi-directionally coupled to the fabric blade 340.

More than one of any or all components may be present within the management blade 330. For example, a plurality of bridges substantially identical to bridge 450 may be used and would be bi-directionally coupled to the system controller 410, and a plurality of MACs substantially identical to the MAC 460 may be used and would be bi-directionally coupled to the bridge 450. Again, other connections may be made and memories (not shown) may be coupled to any of the components within the management blade 330. For example, content addressable memory, static random access memory, cache, first-in-first-out (“FIFO”), or other memories or any combination thereof may be bi-directionally coupled to the FPGA 430.

The control blade 310, the management blades 330, or both may include a central processing unit (“CPU”) or controller. Therefore, the appliance 250 is an example of a data processing system. Although not shown, other connections and memories (not shown) may reside in or be coupled to any of the control blade 310, the management blade(s) 330, or any combination thereof. Such memories can include, content addressable memory, static random access memory, cache, FIFO, other memories, or any combination thereof. The memories, including the disk 390 can include media that can be read by a controller, CPU, or both. Therefore, each of those types of memories includes a data processing system readable medium.

Portions of the methods described herein may be implemented in suitable software code that includes instructions for carrying out the methods. In one embodiment, the instructions may be lines of assembly code or compiled C⁺⁺, Java, or other language code. Part or all of the code may be executed by one or more processors or controllers within the appliance 250 (e.g., on the control blade 310, one or more of the management blades 230, or any combination thereof) or on one or more software agent(s) (not shown) within network devices 232-237, or any combination of the appliance 250 or software agents. In another embodiment, the code may be contained on a data storage device, such as a hard disk (e.g., disk 390), magnetic tape, floppy diskette, CD ROM, optical storage device, storage network (e.g., storage network 136), storage device(s), or other appropriate data processing system readable medium or storage device.

Other architectures may be used. For example, the functions of the appliance 250 may be performed at least in part by another apparatus substantially identical to appliance 250 or by a computer (e.g., console 380). Additionally, a computer program or its software components with such code may be embodied in more than one data processing system readable medium in more than one computer. Note that the appliance 250 is not required, and its functions can be incorporated into different parts of the distributed computing environment 200 as illustrated in FIGS. 2 and 3.

Attention is now directed to specific aspects of the distributed computing environment, how it is controlled by its management infrastructure, and how problems with conventional approaches to managing distributed computing systems are overcome.

Each of the network devices 232-237 is directly connected to the appliance 250 via the network 212. Substantial all of the network traffic to and from the network devices 232-237 passes through the appliance 250, and more specifically, at least one on the management blades 330. By routing substantially all of the network traffic to and from the network devices 232-237, the appliance 250 can more closely manage and control the distributed computing environment 200 in real time or near real time. The distributed computing environment 200 dynamically changes in response to (1) applications running with the distributed computing environment 200, (2) changes regarding components within the distributed computing environment 200 (e.g., provisioning or de-provisioning a server), (3) changes in priorities of applications, transaction types, or both to more closely match the business objectives of the organization operating the distributed computing environment, or (4) any combination thereof.

Along similar lines, substantially all network traffic between any two of the network devices 232-237 passes through the appliance 250, and more specifically, at least one of the management blades 330 via the network 212. The network traffic on the network 212 includes content traffic and management traffic. Therefore, the network 212 is a shared network. Separate, parallel networks for content traffic and management traffic are not needed. The shared network keeps capital and operating expenses lower.

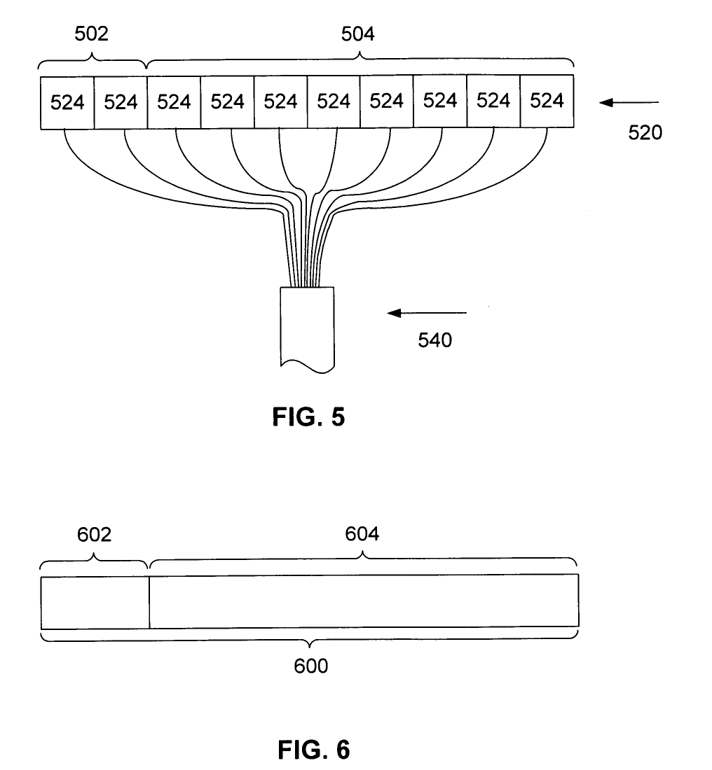

In one embodiment, the network 212 can include one or more connections, a portion of the bandwidth within the network, or both, that may be reserved for management traffic and not be used for content traffic. Referring to FIG. 5, a network cable 540 may be attached to a connector 520. Connections 522 may be reserved for management traffic, and connections 524 may be reserved for content traffic. Referring to FIG. 6, network traffic may include a bandwidth 600. The bandwidth 600 may include a portion 602 reserved for management traffic and a portion 604 reserved for content traffic. FIGS. 5 and 6 are meant to illustrate and not limit the scope of the present invention.

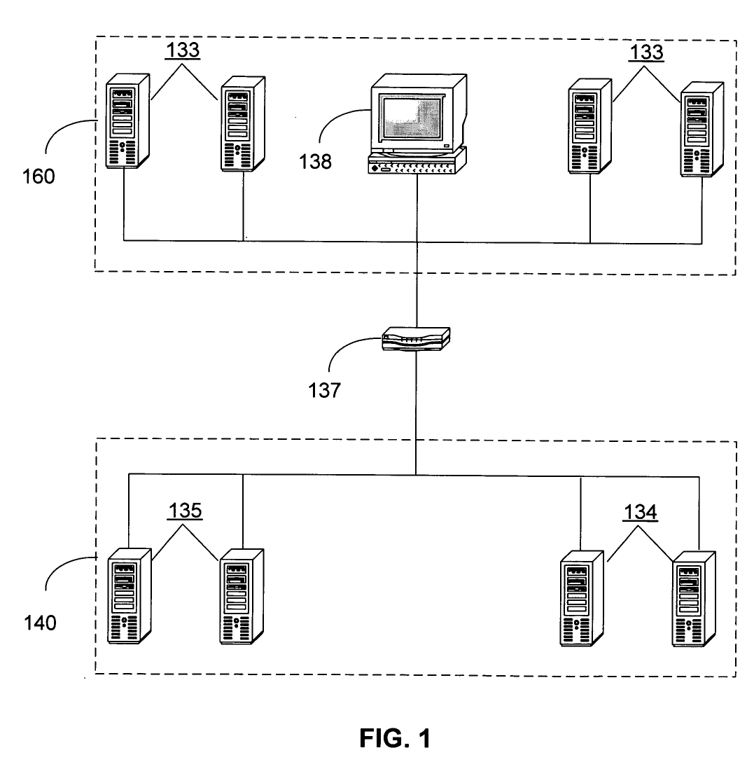

In this manner, the appliance 250 can address an application infrastructure component within any of the network devices 232-237 that may be causing a broadcast storm. The reserved connection(s) or portion of the bandwidth allows the appliance 250 to communicate to the software agent on the application infrastructure component to address the broadcast storm issue. A conventional shared network does not reserve connection(s) or a portion of the bandwidth for management traffic. Therefore, a designated managing component (e.g., workstation 138 in FIG. 1) would not be able to send a management communication to the application infrastructure component because the broadcast storm could consume all connections or bandwidth and substantially prevent any packets, including management packets, from being received by the application infrastructure component causing the broadcast storm. After reading this specification, skilled artisans will appreciate that the distributed computing environment 200 has the advantages of a separate parallel network but without its disadvantages, and with the advantages of a shared network but without its disadvantages.

In another embodiment, each of the management blades 330 can extract management traffic from the network traffic or insert management traffic into the network traffic; send, receive, or transmit management traffic to or from any one or more of the appliance and software agents residing on the application infrastructure components; analyze information within the network traffic; modify the behavior of managed components in the application infrastructure; or generate instructions or communications regarding the management and control of any portion of the application infrastructure; or any combination thereof. The various elements within the management blades 330 (e.g., system controller 410, CPU 420, FPGA 430, etc.) provide sufficient logic and resources to carry out the mission of a management execution component. Also, those elements allow the management blades 330 to respond very quickly to provide real time or near real time changes to the distributed computing environment 200 as conditions within the distributed computing environment 200 change.

In one specific embodiment, the management blade 330 may serve one or more functions of one or more of the network devices connected to it. For example, if one of the firewall/routers 237 is having a problem, the management blade 330 may be able to detect, isolate, and correct a problem within such firewall/router 237. During the isolation and correction, the management blade 330 can be configured to perform the routing function of the firewall/router 237, which is an example of a Layer 3 device in accordance with the OSI Model. This non-limiting, illustrative embodiment helps to show the power of the management blades 330. In other embodiments, the management blade may serve any one or more functions of many different Layer 2 or higher devices.

Another advantage with the embodiment described is that communications to and from a network device is not dependent on another network device. In a conventional distributed computing environment, such as the one illustrated in FIG. 1, the ability of the workstation 138 to communicate any of the application servers 134 or database servers 135 depends on the state of the router 137. Therefore, the router 137 is an intermediate network device with respect to communications between the workstation 138 and the servers 134 and 135. Unlike the conventional distributed computing environment, as illustrated in FIG. 1, the distributed computing environment 200 described herein allows direct communication between the appliance and any of the network devices 432-437 without having to depend on the state of the other network devices because there are no intermediate network devices.

In one particular embodiment, the network devices 232-237 may be directly connected to more than one management blade 230. In effect, network device 232-237 may be connected in parallel to different management blades 230 to account for possible failure in any one particular management blade 230. For example, the control blade 310 may detect that one of the web servers 233 is configured incorrectly. However, one of the management blades 330 may be malfunctioning. Control blade 310 may send a management communication through hub 320 and over a functional management blade 330 to the malfunctioning web server 233. Therefore, the malfunctioning management blade 330 is not used. By connecting network devices 232-237 to network ports on different management blades 330, failures in a specific management blade 330, a specific network link 212, or a specific network port on network devices 232-237 may be circumvented. Such redundancy may be desired for enterprises that require operations to be continuous around the clock (e.g., automated teller machines, store front applications for web sites, etc.).

Embodiments can allow for network devices within a distributed computing environment to be no more than “one hop” away from its nearest (local) management blade 230. By being only one hop away, the management infrastructure can manage and control network devices 232-237 and their corresponding components in real time or near real time. The distributed computing environment 200 can also be configured to allow a single malfunctioning application infrastructure component from bringing down the entire distributed computing environment 200.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

What is claimed is:

1. A distributed computing environment, comprising:
at least one appliance that controls the distributed computing environment;
network devices; and
a network lying between each of the network devices and the at least one appliance, wherein:
the network is configured to allow content traffic and management traffic within the distributed computing environment to travel over the same network; and
the network is configured such that at least one of a connection or bandwidth within the network is reserved for management traffic and is not used for content traffic.

2. The distributed computing environment of claim 1, wherein each of the network devices is directly connected to the at least one appliance.

3. The distributed computing environment of claim 1, wherein the distributed computing environment is configured so that substantially all network traffic to and from each of the network devices passes through the at least one appliance.

4. The distributed computing environment of claim 1, wherein:
the at least one appliance comprises a central management component and at least one management execution component;
each of the network devices comprises a software agent; and
a management infrastructure comprises the central management component, the at least one management execution component, the software agents, and at least a portion of the network.

5. The distributed computing environment of claim 4, wherein the management execution component is operable to detect a problem on at least one network device, correct the problem on the at least one network device, isolate the at least one network device, or any combination thereof.

6. The distributed computing environment of claim 4, wherein the distributed computing environment is configured so that substantially all network traffic between any two network devices passes through the at least one management execution component.

7. The distributed computing environment of claim 4, wherein an application infrastructure comprises the at least one management execution component, the network devices and software agents, and at least a portion of the network.

8. The distributed computing environment of claim 7, wherein the central management component is not part of the application infrastructure.

9. The distributed computing environment of claim 1, wherein the network devices comprise at least one Layer 2 device and at least one Layer 3 device.

10. The distributed computing environment of claim 1, wherein at least one of the network devices comprises a Layer 2 device and a Layer 3 device.

11. The distributed computing environment of claim 1, wherein the at least one management execution component is configured to perform a routing function of a Layer 3 device.

12. A distributed computing environment, comprising:
at least one appliance that controls the distributed computing environment, wherein the at least one appliance comprises a central management component and at least one management execution component; and
network devices, wherein substantially all network traffic between any two network devices passes through the at least one management network component.

13. The distributed computing environment of claim 12, wherein each of the network devices is directly connected to the at least one management execution component.

14. The distributed computing environment of claim 12, further comprising a network lying between each of the network devices and the at least one appliance, wherein the network is configured to allow content traffic and management traffic within the distributed computing environment to travel over the same network.

15. The distributed computing environment of claim 12, wherein:
each of the network devices comprises a software agent; and
a management infrastructure comprises the central management component, the at least one management execution component, the software agents, and at least a portion of a network between the network devices and the at least one appliance.

16. The distributed computing environment of claim 15, wherein an application infrastructure comprises the at least one management execution component, the network devices and the software agents, and at least a portion of the network.

17. The distributed computing environment of claim 16, wherein the central management component is not part of the application infrastructure.

18. The distributed computing environment of claim 12, wherein the management execution component is operable to detect a problem on at least one network device, correct the problem on the at least one network device, isolate the at least one network device, or any combination thereof.

19. The distributed computing environment of claim 12, wherein the network devices comprise at least one Layer 2 device and at least one Layer 3 device.

20. The distributed computing environment of claim 12, wherein at least one of the network devices comprises a Layer 2 device and a Layer 3 device.

21. The distributed computing environment of claim 12, wherein the at least one management execution component is configured to perform a routing function of a Layer 3 device.
